(19) United States
(12) Patent Application Publication
(10) Pub. No.: US 2002/0062392 A1
(43) Pub. Date: May 23, 2002

(54) Communication between networks based on different protocols

(75) Inventors: Youichiro Nishikawa, Osaka (JP); Takeshi Yumura, Osaka (JP); Ryu Katayama, Osaka (JP)

Correspondence Address: LYON & LYON LLP, 633 WEST FIFTH STREET, SUITE 4700, LOS ANGELES, CA, 90071, US

(73) Assignee: SANYO ELECTRIC CO., LTD.

(21) Appl. No.: 09/881,912

(22) Filed: Jun. 15, 2001

(30) Foreign Application Priority Data
Jun. 19, 2000 (JP) JPA 2000-183158

(51) Int. Cl. G06F 15/16

(52) U.S. Cl. 709/246; 709/230

(57) ABSTRACT

Various appliances and devices are connected to various kinds of networks. An AV system network and a cooking system network are independent from each other. To control an appliance in the cooking system network from the AV system network, an AV system server, receiving a direction from a user, generates a file in which the control for the appliance is described in a reserved or a universal information format which is not used in the AV system network. The file is sent to the cooking system network. The cooking system server temporarily converts the information format or the file to a reserved information format which is not used in the cooking system network. The cooking system server, interpreting the converted file, generates a final command for the target appliance.

### BACKGROUND OF THE INVENTION

1. Field of the Invention

This invention relates to a network technique, especially to control a network server which manages a network designed on a dedicated protocol and a network system which contains a plurality of network servers of the above type.

2. Description of the Related Art

It is expected that home networks will play a more and more important role as demand increases for devices to create a more comfortable life environment in line with personal preferences, and as information technology (IT), including network technology becomes more refined. Until recently, the idea of controlling various home electrical appliances from outside via a home network was merely a long-held dream. Today, technical solutions to achieve this dream are at hand. People have strong expectations and various wishes concerning home networks, as they now have direct experience of the convenience of networks such as the Internet.

Various home appliances, however, tend to be segmented and linked to different networks based on their technical history, electric characteristics and purposes. Today, digital TV sets, digital cameras, digital VCRs and other audiovisual (AV) devices are often connected in a network which is in compliance with IEEE 1394 to mutually transmit and receive digital image data. On the other hand, electric appliances in a kitchen and a living room such as a refrigerator and an air conditioner may be linked via an electricity wire or a power line, on which control signals are superposed. The IEEE 1394 based network and power line based network are by their nature not compatible and each forms an independent system network. Data exchange and control bridging different independent system networks are generally difficult to achieve.

This embodiment aims to provide a technique to exchange information smoothly between different independent system networks and to provide a seamless service in which users need not be aware of the differences in physical aspect and protocol.

### SUMMARY OF THE INVENTION

It is therefore an object of the present invention to provide a network server and system which make it easier to communicate and exchange information smoothly between different independent system networks each designed on a different basis. The present invention provides a seamless service where users need not be aware of the differences in the design concept, physical characteristics and protocol of the independent system networks.

The objects are achieved by combinations described in the independent claims. The dependent claims define further advantageous and exemplary combinations of the present invention.

According to one aspect of the present invention, a network system is provided. The system comprises a plurality of independent system networks which are designed on different protocols; a plurality of independent system network servers (hereinafter simply referred to as “servers”), each server controlling, managing or supervising one of the independent system networks; and a backbone system network which interconnects the servers. Each of the servers comprises a communication unit which communicates with other servers via the backbone system network; and a format converter which converts between a first information format and a second information format, the first format being used for managing appliances included in an independent system network which the server is controlling and the second format being used for exchanging information with other servers. The first format is defined for a specific appliance existent within the said independent system network and the second format is defined for an unspecified appliance existent within the said independent system network.

Here, the protocols of the independent system networks and the backbone system network are arbitrary and regardless of whether they are wireless or not, whether they are electric, magnetic, optical or not.

In this configuration, the first format is used for each server to control devices or appliances in a respective independent system network. The devices here are known beforehand for the first format. “Control” means not only “influence” in any sense, but also “acquire the status of the device,” “maintain or manage the condition of the device” and so on. The second format, on the other hand, has a feature to be universal or general purpose to cope with various unspecified or unknown devices. This format may be a reserved format, which can more readily distinguish information to an unidentified device from information for known existing devices on the network.

The second format may be defined in such a manner that the format becomes universal within the said independent system network. The format converter may conduct conversion referring to a table indicating correspondence between the second formats, each format having universality within a respective independent network.

The system may further comprise a command generator which converts to a command dedicated to the appliance a description of control of the appliance written in the first format converted from the second format and which sends the command to the appliance. For example, when server A sends a request for device control in a second format to server B in a different independent system network, the server B first converts the request to a corresponding one in the first format and then converts it to a command dedicated at the target device.

According to yet another aspect of the present invention, a network server is provided. The server is connected to a backbone system network, controlling an independent system network based on a dedicated protocol and comprises a communication unit which communicates with outside via the backbone system network; a former converter which converts between a first information format and a second information format, the first format being used for managing appliances included in an independent system network which the server is controlling and the second format being used for exchanging information with outside; and wherein the first format is defined for a specific appliance existent within the said independent system network and the second format is defined for an unspecified appliance existent within said independent system network. In this configuration, the effects of the aforementioned network system are realized with the server functions.

The network server may further comprise an appliance selector which selects an appliance to control; and an information exchange file generator which generates in the second format description of control of the selected appliance if the selected appliance is not existent within the independent system network the server controls and which sends the generated description.

According to yet another aspect of the present invention, a network system is provided. The system comprises a plurality of independent system network servers, each server controlling one of a plurality of independent system networks designed on different protocols; and a backbone system network which interconnects the servers. The servers, on mutual agreement, use via the backbone system network a practically reserved information format other than a format to be used for controlling an appliance existent within an independent system network which each server controls so that control of an appliance over different independent system networks can be conducted. “A practically reserved information format” may be the aforementioned second format or may be any other format different from one dedicated to a specific known device.

This summary of the invention does not necessarily describe all necessary features so that the invention may also be a sub-combination of these described features.

### BRIEF DESCRIPTION OF THE DRAWINGS

FIG. 1 shows the structure of a home network system according to one preferred embodiment of the present invention.

FIG. 2 shows the structure of an AV system server according to the embodiment.

FIG. 3 shows the internal data structure of an AV system control table.

FIG. 4 shows the internal data structure of a corresponding table.

FIG. 5 shows the internal data structure of a cooking system control table.

FIG. 6 shows the internal data structure of a file for information exchange generated by the AV system server.

FIG. 7 shows the internal data structure of a file for information exchange generated by the cooking system server.

FIG. 8 shows the final command described in XML generated by the cooking system server.

FIG. 9 is a flowchart to show a process to generate a file for information exchange by the AV system server.

FIG. 10 is a flowchart to control the target appliance based on the file for information exchange received by the cooking system server.

### DETAILED DESCRIPTION OF THE INVENTION

The invention will now be described on the basis of the preferred embodiments. This does not intend to limit the scope of the present invention, but exemplify the invention.

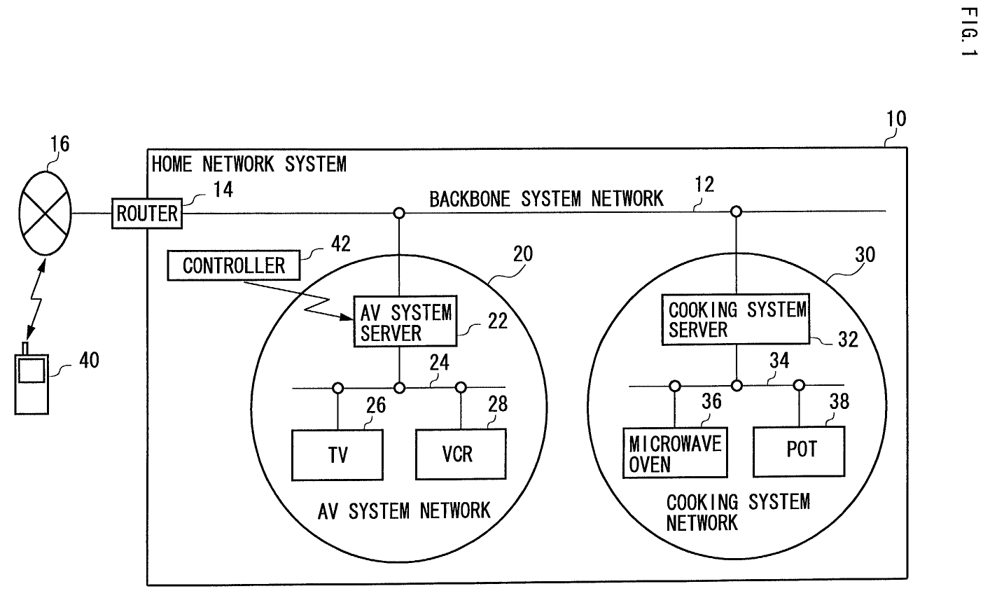

FIG. 1 shows the configuration of a home network system 10 according to one embodiment of the present invention. The system 10, which is installed in a user's house, has a backbone system network 12 to which an AV system network 20, a cooking system network 30 and other independent system networks (not shown) are connected. The backbone system network 12 is connected to the Internet 16 via a router 14. The user uses a mobile terminal 40 to control the home network system 10 from outside.

The AV system network 20 comprises an AV system server 22, a television 26, a digital VCR 28 and other AV appliances, all of which are connected to the AV system network 20 via an AV system network bus 24. The cooking system network 30 comprises a cooking system server 32, a microwave oven 36, a pot 38 and other cooking related appliances. An electric wire to supply power to the appliances is used as a cooking system network bus 34.

A controller 42, which is originally a remote controller of the television 26, issues an instruction or a “direction” to the AV system server 22. When the direction is for controlling an appliance within the AV system network 20, the AV system server 22 directly issues a command to the appliance. On the other hand, when the direction is for controlling an appliance inside the other independent system network (which is hereinafter exemplified by the cooking system network 30), the AV system server 22 generates a file described in an information format which is reserved by the system or used universally among the appliances existing inside the AV system network 20. The AV system server 22 sends the generated file to the cooking system server 32 inside the cooking system network 30. The information format is considered to be or expressed to be “universal” in that it is not directed at a specified appliance within the AV system network 20, but to an unspecified appliance.

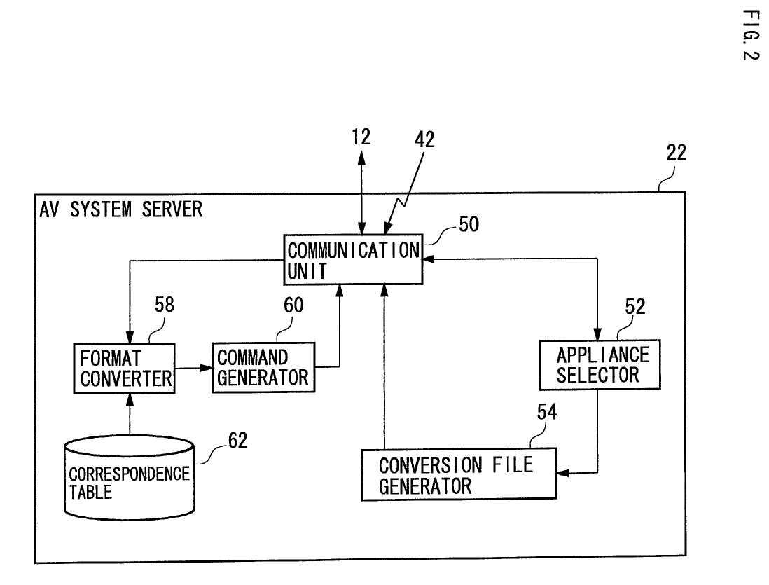

FIG. 2 shows the structure of the AV system server 22. The structure may be realized with hardware elements such as a central processing unit of a computer and memory, and software components such as various function programs loaded in the memory. It is easily understood by anyone skilled in the art that FIG. 2 is drawn in terms of function blocks with an arbitrary combination of hardware and software.

There are several known methods to control appliances inside the AV system network 20 when the user sends a direction to the AV system server 22 by the controller 42. Here, discussion is focused on how to control appliances inside the cooking system network 30 by means of the user's direction issued from the controller 42.

A communication unit 50 is a function block to communicate with the backbone system network 12 and the controller 42. An appliance selector 52 is a function block to specify an appliance the user wishes to control. When the user pushes a predetermined button on the controller 42, the selector 52 makes the television 26 display a screen for selection (not shown), for example, via the communication unit 50. When the user selects “microwave oven” on the screen, the selection is acquired by the selector 52 and is transmitted to an information exchange file generator 54.

The file generator 54 generates an information exchange file, which is hereinafter referred simply as a “file.” The file is generated by describing the user's direction in a universal format when the direction is directed at an appliance in the cooking system network 30. The term “universal,” however, does not necessarily mean that it is completely standardized among a plurality of independent system networks. It is sufficient to be “universal” when the information format is not directed at a specified appliance within the AV system network 20, but at “an arbitrary appliance.” In this sense, the universal information format may be somewhat localized in each independent system network.

The reason the “local universality” is allowed is that it is practically impossible to standardize perfectly a protocol to control various appliances in different independent system networks which are based on different formats and that it is necessary to consider any future appliances and networks. Such standardization is difficult not only in technical terms but also in terms of cost and maintenance. Each independent system network can be optimized in each closed independent environment. This is the background of the notion “local universality” which is introduced to achieve global design bridging different independent networks and at the same time to nevertheless maintain the freedom of design for each independent network.

The cooking system server 32 receives the file and senses that the file is for controlling an appliance which is managed by the cooking system server 32. The server 32 first converts the file into a direction which has a local universality within the cooking system network 30. The cooking system server 32 then converts the direction to a command for the targeted appliance. Control of appliances through local universality among a plurality of independent system networks may be analogous to the situation where different peoples can communicate through a common language English, although each people speaks somewhat localized ones.

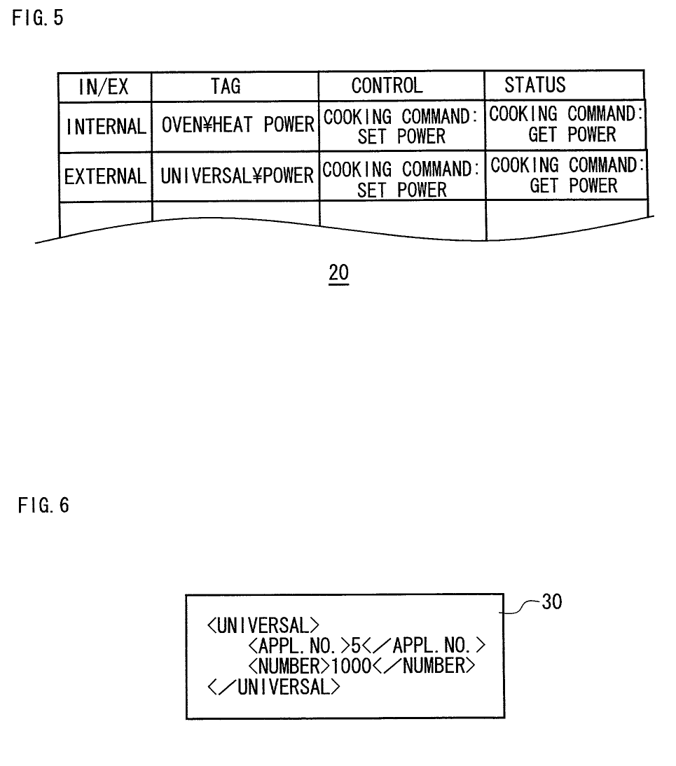

In one embodiment, the file is written in Extensible Markup Language (XML). XML is suitable in this situation as 1) it is generally easy for a user to define tags, 2) it is expected to be widely used, 3) it is generally easy to handle as it is a text base, and 4) it is not overstrict in syntax. The generated file is transmitted to the cooking system network 30 via the communication unit 50. The content of the file is described later in FIG. 5. The communication unit 50, the appliance selector 52 and the file generator 54 constitute a technical portion to “generate a file and send it.”

The communication unit 50, a format converter 58, a command generator 60 and a correspondence table 62, on the other hand, constitute a technical portion to “receive a file and control an appliance.” The direction the AV system server 22 received from the user is for the cooking system network 30 in the above example. Contrarily, a direction from a user received by the cooking system server 32 may be for the AV system network 20. For this symmetry, a file generated by the cooking system server 32 for the AV system network 20 is transmitted to the format converter 58 via the communication unit 50. The file contains a universal description inside the cooking system network 30 for controlling an appliance in the AV system network 20. The format converter 58 converts the description to a corresponding universal description used in the AV system network 20. The correspondence table 62 stores the correspondence between the universal description in the cooking system network 30 and that in the AV system network 20, to be referred to when the conversion is conducted. After the conversion is finished, the command generator 60 generates a command for the target appliance and actually controls the appliance via the communication unit 50.

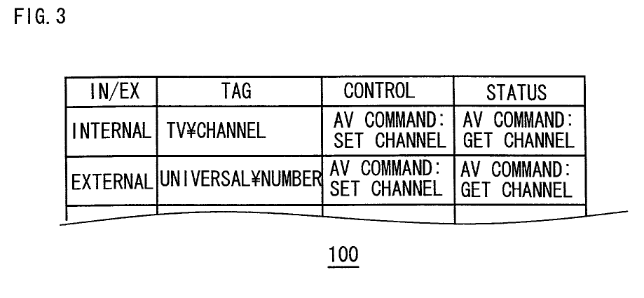

FIG. 3 shows an AV system control table 100 describing the function inside the AV system network 20 of a button (not shown) “channel” of the controller 42. Here, the “channel” button corresponds to the “channel” tag existing in a layer which is under the “TV” tag with regard to the television 26 which is a specific appliance in the AV system network 20. “¥” stands for a layer in this figure. For example, when the appliance to be controlled is the television 26 and the “channel” button is pushed, the AV system server 22 generates a file to control the channel of the television 26 as follows:

<television>

<channel>10</channel>

</television>

The file is used not to send a direction to the cooking system network 30 but to control the television 26 from the AV system server 22. More specifically, the file is for “SET CHANNEL” in the control column. When the user wishes to know the present channel, another file (not shown) is generated corresponding to “GET CHANNEL” indicated in the status column. The AV system server 22, however, usually controls the television 26 by sending a direct command thereto and the files for the television 26 are unnecessary. The files are explained for the convenience of understanding of the situation where a direction is sent to the cooking system network 30.

Now it is assumed that the external appliance to be controlled is a “microwave oven” when the “channel” button of the controller 42 is pushed. The information exchange file generator 54 of the AV system server 22 then generates a tag structure “UNIVERSAL¥NUMBER” as a universal description shown in FIG. 3. This universal description has the same meaning as “TV¥CHANNEL” for the control column and the status column inside the AV system network 20. This structure allows the cooking system server 32 to control the channel of the television using a universal direction.

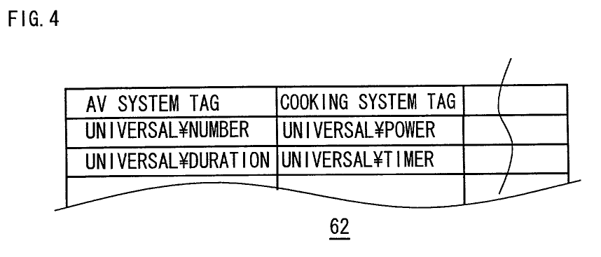

FIG. 4 shows the internal data structure of the correspondence table 62. The correspondence between AV system tags and cooking system tags is shown. The AV system tag “UNIVERSAL¥NUMBER” corresponds to the cooking system tag “UNIVERSAL¥POWER.”

FIG. 5 shows the internal data structure of a cooking system control table 120 contained in the cooking system server 32. Now the “UNIVERSAL¥NUMBER” of the AV system control table 100 corresponds to the “UNIVERSAL¥POWER” of the cooking system control table 120. When the microwave oven 36 is controlled by the controller 42, the “UNIVERSAL¥POWER” of the FIG. 5 is first specified from the “UNIVERSAL¥NUMBER” of FIG. 3 via FIG. 4. Then the target tag, which is an internal tag of the cooking system network 30, is specified as the “OVEN¥HEAT POWER” shown in FIG. 5. In this structure, the user can control the heat power of the oven 36 in a remote room by instructing the AV system server 22 with the “channel” of the button of the controller 42.

FIG. 6 shows a file 130 generated by the information exchange file generator 54 of the AV system server 22 for the above control. Here, the microwave oven 36 is given with appliance number “5” as a unique number. The cooking system server 32 can detect whether the target appliance of the file 130 exists within the cooking system network 30 based on the appliance number. The appliance number or address may be included in a header region (not shown) of the file. The number “1000” (which has been designated by the user with channel buttons) is embedded as a number tag for the “UNIVERSAL¥NUMBER.” The file 130 is sent to the cooking system server 32 via the communication unit 50.

FIG. 7 shows the internal data structure of a file 150 converted by the cooking system server 32 from the file 130 shown in FIG. 6. The cooking system server 32 comprises the same or corresponding components as the AV system server 22 shown in FIG. 2 so that the format converter 58 within the cooking system server 32 converts the file 130 shown in FIG. 6 to the temporary file 150 shown in FIG. 7 referring to the correspondence table 62. The tag “UNIVERSAL¥NUMBER” is converted to the tag “UNIVERSAL¥POWER.”

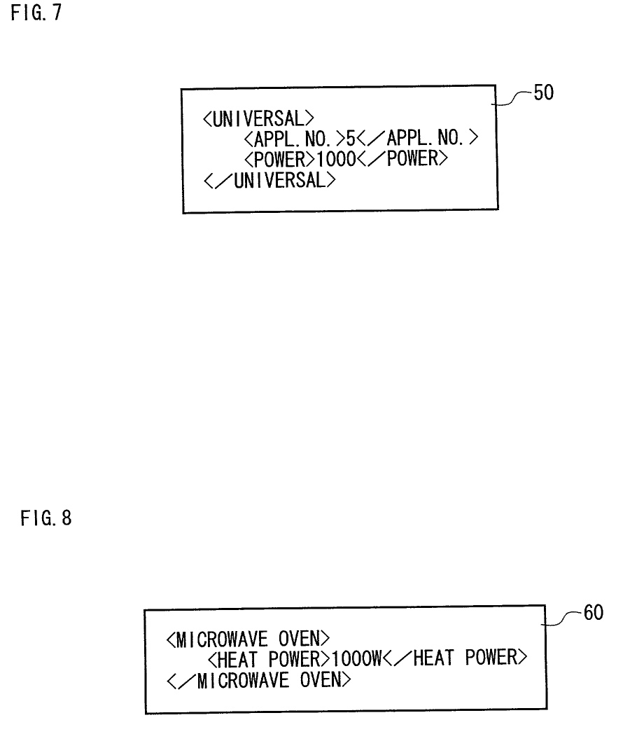

The command generator 60 of the cooking system server 32 then converts the file 150 shown in FIG. 7 to a command to control the oven 36. As a result, the tag <HEAT POWER> under the tag <MICROWAVE OVEN> shown in the final file 160 sets or changes the heat power of the oven 36 to “1000 Watt.” The command generated by the command generator 60, however, may be described in code which is generally different from a description by XML. The file 160 is shown in Small Machine Language (SML) format in FIG. 8 for the ease of understanding.

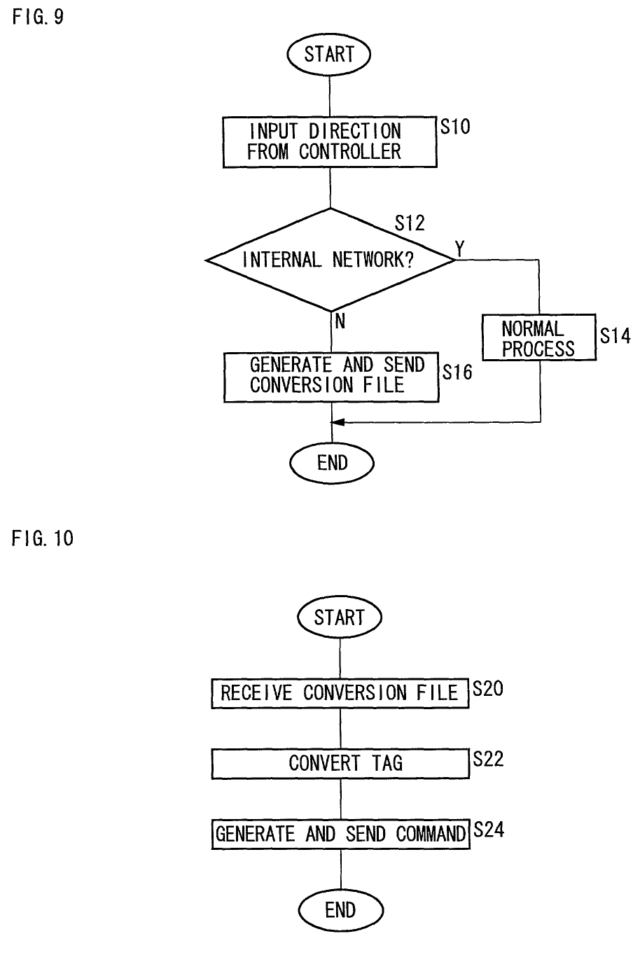

FIG. 9 shows a process to generate an information exchange file. The process is conducted by the AV system server 22. The communication unit 50 inputs a direction the user has issued with the controller 42 (S10). The communication unit 50 determines whether the appliance to be controlled exists inside the network to which the communication unit 50 belongs. When the appliance is confirmed to be inside the network (S12Y), a normal process is conducted to control the appliance (S14) and the process is terminated. When the appliance is confirmed to be outside the network (S12N), the information exchange file generator 54 generates the file 130 for information exchange shown in FIG. 6 and sends the file to the target server (S16).

FIG. 10 shows the process conducted by the cooking system server 32 on receiving the file generated in the process of FIG. 9. When the cooking system server 32 receives the file 130 for information exchange (S20), it converts tags referring to the correspondence table 62 shown in FIG. 4, the AV system control table 100 shown in FIG. 3 and the cooking system control table 120 shown in FIG. 5 (S22). The file 150 shown in FIG. 7 is then generated. The command generator 60 generates the final command and sends it to the target appliance (S24).

Although the present invention has been described by way of exemplary embodiments, it should be understood that many changes and substitutions may be made by those skilled in the art without departing from the spirit and the scope of the present invention which is defined only by the appended claims. A few modifications are now explained.

The user may control the home network system 10 via the Internet 16 from outside using the mobile terminal 40, which is different from the controller 42 used inside home. The user has only to input a description which is universal in the independent system networks such as the tag “UNIVERSAL¥NUMBER” in FIG. 3 and the appliance number to control an arbitrary appliance connected to an arbitrary network. The user does not need to be aware of the differences in the networks, so that a seamless service for the user is enabled.

The present invention can be applied to an factory automation/office automation (FA/OA) network, a personal network or any other networks other than the home network. The effect of the present invention can be considered greater in a combination of networks which are more different from each other.

Naturally, the command formats and syntax for appliances may be standardized using XML and so on.

Any appliances other than servers can generate a file for information exchange to send the file spontaneously to other appliances without the help of servers.

What is claimed is:

1. A network system comprising:
a plurality of independent system networks which are designed on different protocols;
a plurality of independent system network servers, each server controlling one of the independent system networks;
a backbone system network which interconnects the servers;
wherein each of the servers comprises:
a communication unit which communicates with other servers via the backbone system network; and
a format converter which converts between a first information format and a second information format, the first format being used for managing appliances included in an independent system network which the server is controlling and the second format being used for exchanging information with other servers; and
wherein the first format is defined for a specific appliance existent within said independent system network and the second format is defined for an unspecified appliance existent within said independent system network.

2. The system of claim 1 wherein the second format is defined in such a manner that the format becomes universal within the said independent system network and wherein the format converter conducts conversion referring to a table indicating correspondence between the second formats, each format having universality within a respective independent network.

3. The system of claim 1 further comprising a command generator which converts to a command dedicated to the appliance a description of control of the appliance written in the first format converted from the second format and which sends the command to the appliance.

4. The system of claim 2 further comprising a command generator which converts to a command dedicated to the appliance a description of control of the appliance written in the first format converted from the second format and which sends the command to the appliance.

5. A network server connected to a backbone system network, controlling an independent system network based on a dedicated protocol, comprising:
a communication unit which communicates with outside via the backbone system network;
a format converter which converts between a first information format and a second information format, the first format being used for managing appliances included in an independent system network which the server is controlling and the second format being used for exchanging information with outside; and
wherein the first format is defined for a specific appliance existent within said independent system network and the second format is defined for an unspecified appliance existent within said independent system network.

6. The network server of claim 5 further comprising:
an appliance selector which selects an appliance to control; and
an information exchange file generator which generates in the second format description of control of the selected appliance if the selected appliance is not existent within the independent system network the server controls and which sends the generated description.

7. A network system comprising:
a plurality of independent system network servers, each server controlling one of a plurality of independent system networks designed on different protocols; and
a backbone system network which interconnects the servers;
wherein the servers, on mutual agreement, use via the backbone system network a practically reserved information format other than a format to be used for controlling an appliance existent within an independent system network which each server controls so that control of an appliance over different independent system networks can be conducted.

8. A network system controlling method, the system comprising a plurality of independent system networks which are designed on different protocols, a plurality of independent system network servers, each server controlling one of the independent system networks, and a backbone system network which interconnects the servers;
wherein the method makes each of the servers conduct:
communicating with other servers via the backbone system network; and converting between a first information format and a second information format, the first format being used for managing appliances included in an independent system network the server is controlling and the second format being used for exchanging information with other servers; the first format being defined for a specific appliance existent within said independent system network and the second format being defined for an unspecified appliance existent within said independent system network.

9. The method of claim 8 wherein the second format is defined in such a manner that the format becomes universal within said independent system network and wherein the conversion is made referring to a table indicating correspondence between the second formats, each format having universally within a respective independent network.

10. The method of claim 8 further comprising converting to a command dedicated to the appliance a description of control of the appliance written in the first format converted from the second format and sending the command to the appliance.

11. The method of claim 9 further comprising converting to a command dedicated to the appliance a description of control of the appliance written in the first format converted from the second format and sending the command to the appliance.

12. A network system controlling method, the system comprising a plurality of independent system network servers, each server controlling one of a plurality of independent system networks designed on different protocols and a backbone system network which interconnects the servers,
wherein the method makes the servers use via the backbone system network a practically reserved information format other than a format to be used for controlling an appliance existent within an independent system network each server controls so that control of an appliance over different independent system networks is achieved.

13. The system of claim 1 wherein said first format is built on a markup language.

14. The system of claim 1 where in said second format is built on a markup language.

15. The system of claim 1 wherein said second format adopts a universal tag structure.
